(19) United States
(12) Patent Application Publication
(10) Pub. No.: US 2026/0222753 A1
(43) Pub. Date: Jul. 30, 2026

(54) GENERATING AUDIO DRIVING SIGNALS FOR THE PRODUCTION OF SIMULTANEOUS STEREO SOUND STAGES

(71) Applicant: MERIDIAN AUDIO LIMITED, Cambridgeshire (GB)

(72) Inventors: Stephen G. OXNARD, Huntingdon Cambridgeshire (GB); Ethan STANHOPE, Huntingdon Cambridgeshire (GB); Michael P. COUSINS, Huntingdon Cambridgeshire (GB); Samuel J. R. SMITH, Huntingdon Cambridgeshire (GB); Laurence J. HOBDEN, Huntingdon Cambridgeshire (GB)

(21) Appl. No.: 19/159,006

(22) PCT Filed: Feb. 22, 2024
(86) PCT No.: PCT/GB2024/050487

§ 371 Date: Aug. 22, 2025

(30) Foreign Application Priority Data
Feb. 23, 2023 (GB) 2302623.0

(51) Int. Cl. H04S 7/00

(52) U.S. Cl. CPC H04S 7/30

(57) ABSTRACT

A method of generating audio driving signals based on a two-channel stereo audio signal, for use in driving upward-firing transducers, is disclosed. The method comprises: receiving a two-channel stereo audio signal; generating a left audio signal, a right audio signal, and a centre audio signal based on the two-channel stereo audio signal, wherein the left and right audio signals are not positively correlated; generating a first audio signal and a second audio signal based on the left and right audio signals, providing a left audio driving signal for driving an upward-firing left transducer, wherein the left audio driving signal is derived from a summation of the first audio signal and the centre audio signal; and providing a right audio driving signal for driving an upward-firing right transducer, wherein the right audio driving signal is derived from a summation of the second audio signal and the centre audio signal.

### FIELD OF THE INVENTION

The present invention relates to a method of generating audio driving signals based on a two-channel stereo audio signal, the audio driving signals for use in driving upward-firing transducers. The present invention also relates to an audio system configured to output the audio driving signals. More particularly, the present invention is concerned with the location, arrangement and driving signals of/for loudspeakers mounted in the front, and symmetrically around the centre line, of a confined, or small-sized, symmetrical listening space to reproduce simultaneous stereo sound stages for two adjacent listening locations within the space.

### BACKGROUND

Current and future trends in consumer audio systems include the use of loudspeakers that are positioned in locations other than the historically conventional locations such as those of left-right stereo configurations. The reason for this specific trend are manifold, however the justifications and/or use cases which best serve as background to the present invention include: reduced unit size for discretion in a home audio setting and, in particular, for small living space(s) (e.g. as part of a complete audio-visual system); the positioning of audio system loudspeaker units in optimal interior regions for unit packaging in an automotive setting to alleviate issues such as those associated with mounting loudspeakers in vehicle door trims while maintaining stereo sound stage width for multiple occupants; sound reproduction for instances of multiplayer gaming where simultaneous adjacent stereo soundstages may be rendered to accommodate immersive audio with perceptual sonic cues that are congruent with visual cues for multiple listeners. In such envisaged use cases, it is beneficial to provide stereo audio reproduction from a compact and centralised sound reproduction unit. This is a focus of the present invention.

GB 2600 538 A and U.S. Pat. No. 10,880,648 B2, which are examples of previous approaches in the field for such a centralised stereo device, employ pairs of sound sources producing first-order directional audio emission characteristics which may be applied to left-channel and right-channel stereo input audio. In brief, these devices may produce simultaneous stereo sound stages for two adjacent locations by generating directional left-channel and right-channel propagation emitting from side firing sound sources such that the ipsilateral ear of each listener (i.e. the ear on the same side of the listener as the sound sources) is located at a directivity null for the stereo (e.g. either left or right) channel which is intended to be received by the contralateral ear (i.e. the ear on the opposite side of the listener to the sound sources). At the same time, a directional lobe for the channels corresponding to each ipsilateral ear location (central most) is also generated for reception. In this way, a left-right stereo active arc is produced with the potential for further sonic support to the contralateral ear reception by means of reflections within the environment. Both aforementioned approaches possess the disadvantage that they rely on transducer orientations along the horizontal plane or waveguides, which limits the packaging of the device as it cannot be recessed into a surface and have the transducer look directions unobstructed.

GB 2600 539 A offers a similar solution to the two aforementioned approaches but possesses the advantage of deploying upward-firing sound sources. This removes the necessity for the drive units to be waveguided or mounted proud of a surface such as a dashboard in the example use case of a car cabin, which could cause undesirable sound scattering and comb filtering effects from near field surfaces. The flush mounting of the drive units with a surface also marks an improvement in the discretion of the overall system. In one example, the device described in GB 2600 539 A generates simultaneous first-order directivity patterns for left-channel and right-channel audio emission such that the intended signals for ipsilateral and contralateral ears arrive directly/by means of reflection or are greatly diminished in amplitude through null-steering as appropriate (and in line with the notions put forward in GB 2600 538 A and U.S. Pat. No. 10,880,648 B2).

However, such prior art systems are known to suffer from a multitude of unwanted artifacts including suppression of audio content common to both left and right audio streams, and comb-filtering.

An object of the present invention is to overcome these issues.

### SUMMARY OF INVENTION

According to a first aspect of the invention, there is provided a method of generating audio driving signals based on a two-channel stereo audio signal, for use in driving upward-firing transducers, the method comprising the steps of: receiving a two-channel stereo audio signal; generating a left audio signal L_{A}(t), a right audio signal R_{A} (t), and a centre audio C_{A}(t) signal based on the two-channel stereo audio signal, wherein the left and right audio signals are not positively correlated; generating a first audio signal S₁(t) and a second audio signal S₂(t) based on the left and right audio signals, wherein the first audio signal and the second audio signal are generated according to: S₁(t)=R_{A} (t)−L_{A}(t−Δt_{LR}) and S₂(t)=L_{A}(t)−R_{A} (t−Δt_{LR}), where Δt_{LR} is a time delay for the left and right audio signals; providing a left audio driving signal L_{D}(t) for driving an upward-firing left transducer, wherein the left audio signal is derived from a summation of the first audio signal and the centre audio signal; and providing a right audio driving signal R_{D}(t) for driving an upward-firing right transducer, wherein the right audio signal is derived from a summation of the second audio signal and the centre audio signal.

For example, the method may comprise providing the left audio driving signal by summing the first audio signal and the centre audio signal; and providing the right audio driving signal by summing the second audio signal and the centre audio signal.

Preferably, wherein providing the left audio driving signal comprises applying a gain stage to at least one of the first audio signal and the centre audio signal prior to the summation of the first audio signal and the centre audio signal, and/or wherein providing the right audio driving signal comprises applying a gain stage to at least one of the second audio signal and the centre audio signal prior to the summation of the second audio signal and the centre audio signal.

According to a second aspect of the invention, there is provided a method of generating audio driving signals based on a two-channel stereo audio signal, for use in driving upward-firing transducers, the method comprising the steps of: receiving a two-channel stereo audio signal; generating a left audio signal L_{A}(t), a right audio signal R_{A} (t), and a centre audio C_{A}(t) signal based on the two-channel stereo audio signal, wherein the left and right audio signals are not positively correlated; generating a first audio signal S₁(t) and a second audio signal S₂(t) based on the left and right audio signals, wherein the first audio signal and the second audio signal are generated according to: S₁(t)=R_{A} (t)−L_{A}(t−Δt_{LR}) and S₂(t)=L_{A}(t)−R_{A} (t−Δt_{LR}), where Δt_{LR} is a time delay for the left and right audio signals; providing a left audio driving signal L_{D}(t) for driving an upward-firing left transducer, wherein the left audio driving signal is derived from the first audio signal; providing a right audio driving signal R_{D}(t) for driving an upward-firing right transducer, wherein the right audio driving signal is derived from the second audio signal; and providing a centre audio driving signal C_{D}(t) for driving an upward-firing centre transducer, wherein the centre audio driving signal is derived from the centre audio signal.

A common feature to all the aforementioned prior art systems is that there is little consideration as to the nature of the driving signals as received by the output devices, i.e. the transducers (also referred to as sounds sources or drive units). For stereo input driving signals (which may also be referred to as a two-channel stereo audio signal), there typically exists a highly correlated signal component common to both left and right channels. This correlated component is the commonality of the left and right audio streams, which is commonly termed “centre” and usually consists of elements of the audio mix which are centrally panned, namely vocals and some percussive elements. The summation of this correlated component, in either the signal domain before acoustic transmission or in air, can cause a multitude of unwanted artifacts including suppression of the common signal, or comb-filtering. That is, in the aforementioned prior art systems the common signal has not been considered in the first-order polar patterns generated.

The present invention overcomes such issues using signal processing techniques according to the first and second aspects. In particular, the present invention extracts decorrelated left and right audio signal and a centre audio signal channel from conventional stereo audio content (e.g. by means of 2- to 3-channel upmixing techniques), and processes at least the left and right audio signals such that directed regions of cancellation for the left and right audio content may be provided when the resulting left and right audio driving signals (also referred to as left and right audio output signals) are output by upward-facing left and right transducers, whilst also providing the centre audio driving signal (also referred to as a centre audio output signal) based on the centre audio signal for simultaneous output either through both of the upward-facing transducers or through an upward-facing centre transducer.

In this way, the resulting interference and reflection patterns arising in the sound field in the vicinity of the transducers produce two simultaneous stereo soundstages for receipt by two adjacent listeners, which have a reduced number of artifacts compared to prior art systems, particularly in relation to the correlated components of the original left and right audio channels. Although the method of the present invention is particularly advantageous when the audio driving signals are used to drive transducers in a confined (and preferably symmetrical) space, the skilled person will appreciate the audio driving signals generated by the present invention will provide acoustic advantages in all listening environments.

It will be appreciated by the skilled person that the centre audio signal represents the signal (or audio content) common to both channels of the two-channel stereo audio signal. The skilled person will also appreciate that the left and right signals not being positively correlated means that the normalised correlation coefficient of the two (left and right) signals is less than or equal to 0. The left and right signals may also be described as being negatively correlated or substantially decorrelated.

In one embodiment, generating the first audio signal and the second audio signal comprises: generating a copy of each of the left audio signal and right audio signal; inverting the copy of the right audio signal and the copy of the left audio signal; applying a time delay to each of the inverted copy of the right audio signal and the inverted copy of the left audio signal; summing the delayed and inverted copy of the left audio signal and the right audio signal to generate the first audio signal; and summing the delayed and inverted copy of the right audio signal and the left audio signal to generate the second audio signal.

In an alternative embodiment, generating the first audio signal and the second audio signal comprises: generating an inverted copy of each of the left audio signal and right audio signal; generating a time delayed copy of each of the left audio signal and the right audio signal; inverting a summation of the inverted copy of the right audio signal and the delayed copy of the left audio signal to generate the first audio signal; and inverting a summation of the inverted copy of the left audio signal and the delayed copy of the right audio signal to generate the second audio signal.

The skilled person will appreciate that, in further embodiments, the order of these operations (e.g. inversion and delay operations) may be varied.

Preferably, wherein the left audio driving signal is derived from the first audio signal only, wherein the right audio driving signal is derived from the second audio signal only, and wherein the centre audio driving signal is derived from the centre audio signal only.

Preferably, wherein providing the left audio driving signal comprises applying a gain stage to the first audio signal, and/or wherein providing the right audio driving signal comprises applying a gain stage to the second audio signal, and/or wherein providing the centre audio driving signal comprises applying a gain stage to the centre audio signal.

Preferably, wherein the left audio driving signal is the first audio signal, wherein the right audio driving signal is the second audio signal, and wherein the centre audio driving signal is the centre audio signal.

Preferably, the method further comprises generating a third audio signal S₃(t) based on the centre audio signal, wherein the third audio signal is generated according to: S₃(t)=−C_{A}(t−Δt_{C}), where Δt_{C} is a time delay for the centre audio signal, wherein the left audio driving signal is derived from a summation of the first audio signal and one of the centre audio signal and the third audio signal, wherein the right audio driving signal is derived from a summation of the second audio signal and the one of the centre audio signal and the third audio signal, and wherein the centre audio driving signal is derived from the other of the centre audio signal and the third audio signal.

Preferably, wherein providing the left audio driving signal comprises applying a gain stage to at least one of the first audio signal, the centre audio signal, and the third audio signal prior to the summation of the first audio signal and the one of the centre audio signal and the third audio signal, and/or wherein providing the right audio driving signal comprises applying a gain stage to at least one of the second audio signal, the centre audio signal, and the third audio signal prior to the summation of the second audio signal and the one of the centre audio signal and the third audio signal, and/or wherein providing the centre audio driving signal comprises applying a gain stage to the other of the centre audio signal and the third audio signal.

Preferably, wherein a summation of the first audio signal and one of the centre audio signal and the third audio signal is provided as the left audio driving signal, wherein a summation of the second audio signal and the one of the centre audio signal and the third audio signal is provided as the right audio driving signal, and wherein the other of the centre audio signal and the third audio signal is provided as the centre audio driving signal.

In one embodiment, generating the third audio signal comprises: generating a copy of the centre audio signal; inverting the copy of the centre audio signal; applying a time delay to inverted copy of the centre audio signal. Again, the skilled person will appreciate that, in alternative embodiments, the order of these operations (e.g. inversion and delay operations) may be varied.

Preferably, wherein the centre audio driving signal is band-limited. In this way, it is possible to accommodate for a spectral mismatch, e.g. in instances where a tweeter and two midrange drivers are used and the tweeter cannot render the lower frequencies.

Preferably, the time delay Δt_{C} is selected such that, when the left audio driving signal, the right audio driving signal and the centre audio driving signal are used to simultaneously drive respective upward-facing left, right and centre transducers located symmetrically ahead of and between a left listener and a right listener, sound radiation patterns associated with the centre audio signal are output having nulls directed towards the left listener's ipsilateral ear and the right listener's ipsilateral ear.

Preferably, the time delay Δt_{LR} is selected such that, when the left audio driving signal and the right audio driving signal are used to simultaneously drive respective upward-facing left and right transducers located symmetrically ahead of and between a left listener and a right listener, a sound radiation pattern associated with the left audio signal is output having a null directed towards the left listener's ipsilateral ear and a sound radiation pattern associated with the right audio signal is output having a null directed towards the right listener's ipsilateral ear.

Preferably, Δt_{LR} is calculated according to:

$$Δ {t}_{LR} = \frac{τ - α τ}{α} ; α ∈ ( 0 , 1 ]$$

where α is a directivity parameter with 0<α<=1, and

$$τ = \frac{x}{c}$$

where x (m) is a distance between a centre of the upward-facing left and right transducers and c (ms⁻¹) is the speed of sound in air. The skilled person will appreciate that α is selected such that when the left audio driving signal and the right audio driving signal are used to simultaneously drive respective upward-facing left and right transducers located symmetrically ahead of and between a left listener and a right listener, a sound radiation pattern associated with the left audio signal is output having a null directed towards the left listener's ipsilateral ear and a sound radiation pattern associated with the right audio signal is output having a null directed towards the right listener's ipsilateral ear. The skilled person will also appreciate that Δt_{C} may be calculated in a corresponding manner mutatis mutandis.

Preferably the method further comprises generating the left audio signal, the right audio signal, and the centre audio signal by: upmixing the two-channel stereo audio signal to generate a left upmix audio signal L_{U} (t), a right upmix audio signal R_{U}(t), and a centre upmix audio signal C_{U}(t), wherein the left audio signal, the right audio signal, and the centre audio signal are derived from the left upmix audio signal, the right upmix audio signal, and the centre upmix audio signal respectively.

Preferably, wherein the left upmix audio signal, the right upmix audio signal, and the centre upmix audio signal are provided as the left audio signal, the right audio signal, and the centre audio signal respectively.

Preferably, the method further comprises generating the left audio signal, the right audio signal, and the centre audio signal by: upmixing the two-channel stereo audio signal to generate a left upmix audio signal L_{U} (t), a right upmix audio signal R_{U}(t), and a centre upmix audio signal C_{U}(t); and applying a panning algorithm to the left upmix audio signal, the right upmix audio signal, and the centre upmix audio signal to generate the left audio signal, the right audio signal, and the centre audio signal respectively.

Preferably, the panning algorithm generates the left audio signal, the right audio signal, and the centre audio signal in accordance with:

$${C}_{A} ( t ) = {C}_{U} ( t ) \times {G}_{C C}$$

$${L}_{A} ( t ) = {L}_{U} ( t ) + 1 {0}^{\frac{{G}_{M}}{20}} ( {C}_{U} ( t ) \times {G}_{C L} )$$

$${R}_{A} ( t ) = {R}_{U} ( t ) + 1 {0}^{\frac{{G}_{M}}{20}} ( {C}_{U} ( t ) \times {G}_{C R} )$$

where G_{M} is a make-up gain parameter and G_{CL}, G_{CR} and G_{CC} are gain coefficients which are calculated in accordance with:

$${G}_{C L} = \{ \begin{matrix}\sqrt{\vert b \vert} , & b \leq 0 \\ 0 , & b > 0\end{matrix}$$

$${G}_{CR} = \{ \begin{matrix}0 , & b \leq 0 \\ \sqrt{\vert b \vert} , & b > 0\end{matrix}$$

$${G}_{CC} = \sqrt{1 - \vert b \vert}$$

where b is a balance parameter ranging from −1 to 1. It will be understood that b=−1 corresponds to a left balance and b=1 corresponds to a right balance.

Preferably, the method further comprises applying one or more spectral equalisation filters to one or more of the audio driving signals. In this way compensation is made for the spectral colouration introduced through application of null-steering during the derivation of the audio driving signals from the original stereo audio signal.

Preferably, the method further includes applying a first spectral equalisation filter to the left and right audio driving signals and a different second spectral equalisation filter to the centre audio driving signal. In this way, it is possible to accommodate compensation of the different spectral colouration characteristics introduced by distinct null-steering arrangements for the left and right audio driving signals and the centre audio driving signal.

Preferably, the method further comprises comprising applying a gain stage to one or more of the audio driving signals.

Preferably, the method further comprises applying a time delay n_{tc} to the centre audio driving signal or the left and right audio driving signals such that, when the left audio driving signal, the right audio driving signal and the centre audio driving signal are used to simultaneously drive respective upward-facing left, right and centre transducers located ahead of and symmetrically between a left listener and a right listener, sound radiation patterns received by the left and right listeners are time aligned.

Preferably, wherein the time delay in samples n_{tc} is calculated according to:

$${n}_{t c} = \frac{d}{c} F s$$

wherein d is a perpendicular displacement (m) of the upward-facing centre transducer from a line extending between the upward-facing right and left transducers, c is the speed of sound in air (m/s), and Fs is a digital sampling rate of the audio driving signals (Hz).

According to a third aspect of the invention, there is provided a computer readable medium comprising computer executable code which, when executed on one or more processors of an audio system, causes the system to perform the method of the first or second aspect.

According to a fourth aspect of the invention, there is provided a computer program product comprising instructions which, when the program is executed by a computer, cause the computer to carry out the method of the first or second aspect.

According to a fifth aspect of the invention, there is provided an audio system comprising one or more digital signal processors adapted to perform the method of the first or second aspect.

Preferably, the audio system further comprises: an upward-firing left transducer configured to be driven by the left audio driving signal; and an upward-firing right transducer configured to be driven by the right audio driving signal.

Preferably, the audio system further comprises: an upward-firing centre transducer configured to be driven by the centre audio driving signal, wherein the upward-firing centre transducer is located between the upward-firing left and right transducers.

Preferably, wherein the upward-firing centre transducer is offset from a line extending between the upward-firing left and right transducers.

Preferably, wherein the upward-facing centre transducer has different acoustic characteristics to the upward-firing left and right transducers.

Preferably, wherein the upward-firing left and right transducers have substantially the same acoustic characteristics within the audible bandwidth 20 Hz to 20000 Hz.

According to a sixth aspect of the invention, there is provided a vehicle comprising the audio system according to the fifth aspect, wherein the upward-facing transducers are mounted inside a cabin of the vehicle and arranged at the front of the cabin in a loudspeaker system positioned symmetrically about a longitudinal axis of the cabin.

The present invention may also be described as a method for generating driving signals for an arrangement of two or three sound sources, wherein the emission of each sound source contributes to the production of two adjacent, simultaneous stereo soundstages. The method comprises the steps of receiving stereo audio signals for stereo reproduction, deriving, from the stereo audio signals, first and second highly decorrelated left and right soundstage signals and a further centre soundstage channel representing the signal common to both received audio signals by means of 2- to 3-channel upmixing, applying axisymmetric null-steering, with reference to the centre line of the sound source arrangement, to the generated decorrelated left and right soundstage signals sounded from an upward-facing axisymmetric sound source pair to direct the resulting sound towards the geometric limits of the total simultaneous soundstages.

In the first aspect of the invention the centre soundstage channel is provided for output through the sound source pair whereas, in the second aspect of the present invention, the centre soundstage channel is provided for output through an upward-facing central sound source positioned on the centre line of the soundstage, and preferably an expanded centre channel soundstage region can be produced through application of null-steering to the common third centre soundstage signal. In this way, the resulting interference and reflection patterns arising in the sound field in the vicinity of the sound sources produces two simultaneous stereo soundstages as received aurally by two adjacent listeners.

The method of the present invention may also be described as a method for generating audio driving signals configured for use in an audio system comprising left and right upward-facing sound sources preferably arranged in the centre of a confined listening environment, wherein the arrangement is positioned symmetrically around the centre line of the given space. The left and right sound sources are used to produce simultaneous stereo soundstages for left and right listening locations. This is achieved by first extracting largely decorrelated left and right channel signal content from conventional stereo audio content by means of 2- to 3-channel upmixing techniques. These decorrelated signals are then each fed to both drivers via selective delay and level compensation stages.

Considering in isolation the left extent of the reproduced soundstage, upmixed stereo-left content is produced by the left and right upward-facing sound sources by rendering sound cancellation in the region of the left listener's ipsilateral ear. The method of cancellation is derived from null-steering theory for first-order directivity patterns (e.g. dipole, cardioid, hyper-cardioid) as applied to two ideal hemispherical sound sources representing the two upward firing drive units. The effect of the null-steering is threefold. Firstly, the region of cancellation directed towards the left listener's ipsilateral ear (for left extent reproduction) imposes a perceptible interaural level difference (ILD) between direct sound components arriving at ipsilateral and contralateral ears in the left listening location. Secondly, the sound source directivity pattern rendered, when null-steering, is at a maximum magnitude directed to the left of the space, parallel to the centre line. This has the effect of producing strong first-order reflections emitting from surfaces occupying the region front-left of the left listener. These two effects, in combination, produce a left extent which is perceived to tend towards the front left corner of the environment in terms of origin. Simultaneously, the third effect is to produce a right-going directivity magnitude maximum which carries the upmixed stereo-left to the front right listener's ipsilateral ear as expected. For the right extent of the reproduced sound field, the same process implemented in symmetry around the centre line of the space thus completing the simultaneous stereo soundstages for two adjacent listeners.

Given the aforementioned upmixing from 2- to 3-channel audio content, beyond the presentation of extracted left/right channel content, a further concern is the reproduction of the remaining channel, commonly referred to as “centre”. A basic approach, which corresponds to the first aspect of the present invention, produces the centre audio signal, at equal levels, from the left and right upward-facing sound sources in summation with the extracted and processed left-channel and right-channel upmixed signals. An alternative approach, encompassed by the second aspect of the present invention, employs an additional sound source located on the centre line of the space in the region of the two existing sources, through which the centre audio signal is produced while the left and right sound sources produce the extracted and processed left-channel and right-channel upmixed signals.

Such approaches render stereo-centre content which is perceived as originating from the loudspeaker system (in the region of the centre line of the space). In the interest of moving the centre content towards the forward look direction of both adjacent listeners simultaneously, a preferred embodiment of the present invention which is also encompassed by the second aspect of the present invention uses null-steering to direct a region of cancellation of the centre content towards the ipsilateral ear of both listeners by processing the extracted stereo-centre signal and outputting the processed content to all three aforementioned sources in combination. This, in turn, has the effect of directing sound energy towards surfaces in front of the listeners (if present), while decreasing the ILD of the received direct sound component arriving at both occupants. As a result, strong reflections emanating from the region of surfaces in front and to the sides of both occupants (if present) compliment the aforementioned lower ILD such that the stereo-centre audio content is perceived as originating from a more centralised region of the active arcs.

As will be appreciated by those skilled in the art, the present invention is capable of various implementations according to the application.

### BRIEF DESCRIPTION OF DRAWINGS

Embodiments of the invention are now described, by way of example, with reference to the drawings, in which:

FIG. 1 is a schematic plan view of an exemplary listening environment including a loudspeaker system configured to generate left and right simultaneous active arcs for receipt by left and right listeners;

FIG. 2 is a schematic plan view of the exemplary listening environment illustrating a first-order polar radiation pattern corresponding to the left audio content produced by upward-facing left and right transducers;

FIG. 3 illustrates a selection of common polar patterns generated by manipulation of a directivity parameter a;

FIG. 4 is a flowchart showing method steps for generating left and right audio driving signals based on a two-channel stereo audio signal;

FIG. 5 is a schematic diagram illustrating an audio system comprising upward-facing left and right transducers;

FIG. 6 is a flowchart showing method steps for generating left and right driving output signals according to a specific embodiment of FIG. 4;

FIG. 7 is a schematic diagram illustrating an audio system comprising upward-facing left, right and centre transducers;

FIG. 8 is a flowchart showing method steps for generating left, right and centre audio driving signals based on a two-channel stereo audio signal;

FIG. 9 is a flowchart showing method steps for generating left, right and centre audio driving signals according to a specific embodiment of FIG. 8;

FIG. 10 is a flowchart showing method steps for generating left, right and centre audio driving signals according to another specific embodiment of FIG. 8;

FIGS. 11A and 11B are schematic plan views of the exemplary listening environment illustrating first-order polar radiation patterns corresponding to the centre audio content produced by upward-facing left, right and centre transducers;

FIGS. 12A and 12B are schematic plan views of the exemplary listening environment illustrating different arrangements of the upward-facing left, right and centre transducers;

FIG. 13 is a schematic diagram illustrating an audio system comprising upward-facing left, right and centre transducers in which the centre audio driving signal is time delayed.

### DETAILED DESCRIPTION

The present invention may be implemented in several different ways as appropriate for a given listening environment and sound reproduction purpose/scenario. What follows is the description of example implementations for a number of intended use cases with reference to the figures.

This invention is intended to provide audio driving signals (also referred to as audio output signals) configured to generate two simultaneous stereo soundstages for adjacent listening locations receiving representations of the same stereo programme material when the audio driving signals are used to drive a centrally located configuration (herein referred to as a loudspeaker system) of two or more sound sources. The invention is necessary when, for instance, aesthetic discretion, physical size, spacing, location or packaging constraints are of primary importance in the design and deployment of a stereo audio reproduction system.

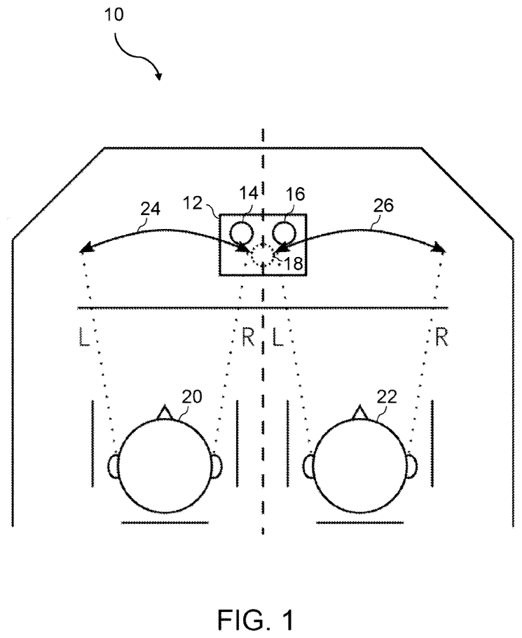

An example use case of this invention is depicted in FIG. 1, which shows an exemplary listening environment 10 including a loudspeaker system 12 configured to generate left and right simultaneous active arcs for receipt by left and right listeners 20, 22. This example relates to the realm of sound reproduction systems in confined, enclosed spaces such as vehicle cabins, modest-sized audiovisual environments, or small office rooms, noting that the current invention is not limited only to such environments and may also be implemented in non-confined listening environments. As illustrated, the invention seeks to produce two soundstage active arcs (where: “L” denotes the left-most extent of a stereo active arc; and “R” denotes the right-most extent of a stereo active arc) which, by design, are significantly wider than the physical dimensions of the loudspeaker system 12 itself. This general example deployment will be used to detail the components of the invention and their modes of operation.

The loudspeaker system 12 comprises a pair of transducers 14, 16 (which may also be referred to as drive units or sound sources) which are located adjacent to one another. In particular, the loudspeaker system 12 comprises a left transducer 14 and a right transducer 16. In other embodiments, as will be discussed further below, the loudspeaker system 12 may also comprise a centre transducer 18.

Each transducer 14, 16 is upward facing such that the transducers 14, 16 (i.e. diaphragms of the drive units) are orientated to be planar with the azimuthal plane in a standard spherical coordinate system with respect to an observer situated at the origin. Additionally, the downward facing portions of the transducers 14, 16 are acoustically decoupled and operate into independent (sealed) volumes to avoid acoustic interaction effects within the overall enclosure. As such, in the case of idealised sound source properties, the radiated sound emitting from each transducer 14, 16 may be modelled using monopole characteristics in the positively elevated directions of the aforementioned coordinate system (i.e. each sound source is assumed to have hemispherical directionality across the usable bandwidth). It is also assumed that the characteristics of all of the transducers 14, 16 are substantially similar within the limits of the audible bandwidth and across the bandwidth of use/operation. While this is not a restriction of the loudspeaker system 12, it simplifies the description of this invention. In use, it is prescribed that the loudspeaker system 12 be positioned symmetrically around the centre line (i.e. the central longitudinal axis as shown as a dashed line in FIG. 1) of the listening environment 10 between and in front of two adjacent listening locations (corresponding to the location of the left and right listeners 20, 22 respectively). The regions between the centre line and the extents of the listening environment 10 on left and right sides define the maximum extent of two active arcs for simultaneous stereo reproduction in front of the listening locations.

Considering the reproduction of material at the left/right limits of the simultaneous active arcs, it is first required that 2- to 3-channel upmixed content be derived from input stereo format audio in such a way that the resulting upmixed left and right channel signals are largely decorrelated. The reason for this requirement will become apparent having first described the reproduction of the two simultaneous and adjacent active arcs. The left and right transducers 14, 16 are responsible for providing the left and right soundstage extents for the two adjacent active arcs. For simplicity, an idealised 2D planar model will be employed to describe the mode of operation for each of the transducers 14, 16.

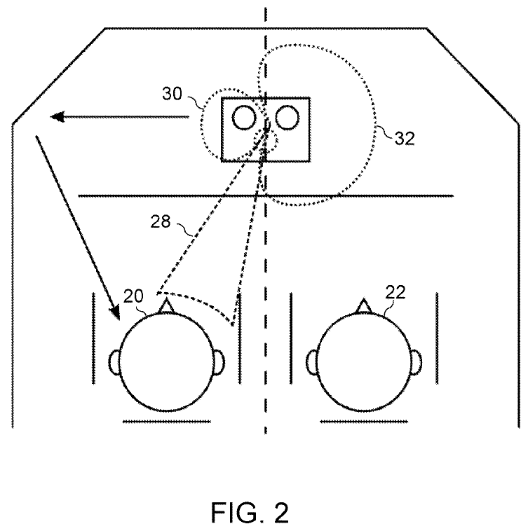

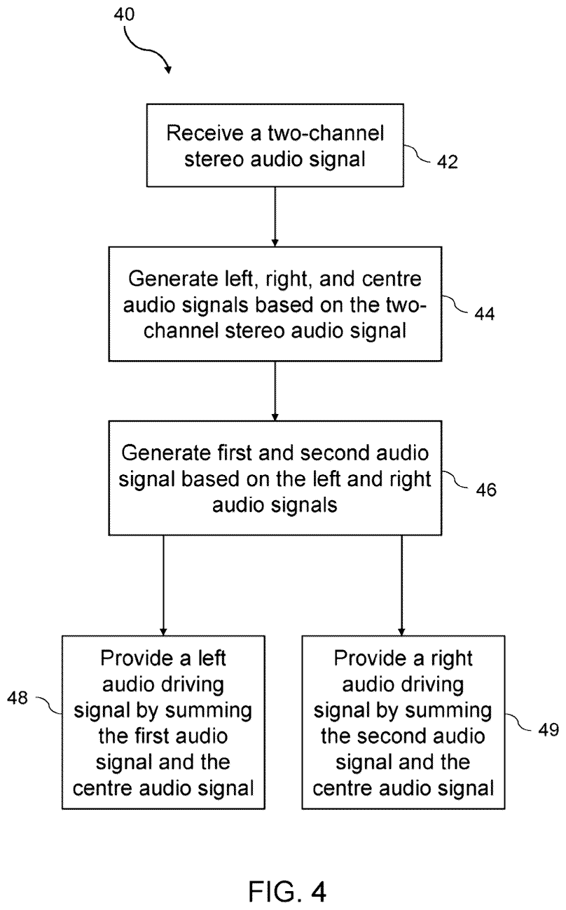

In regard to the reproduction of the simultaneous left extent (i.e. the audio content or sound radiation pattern corresponding to the left channel in a two-channel stereo audio signal), FIG. 2 shows a exemplarily scenario in which the left and right transducers 14, 16 are driven with audio driving signals (also referred to as audio output signals) such that the overall summed radiation pattern describes a first-order polar response function in the azimuthal plane (again, considering the ideal hemispherical source directivities over the azimuthal plane). A method for generating such audio driving signals for the generation of the first-order directivity pattern will be described later with reference to FIG. 4. For reproduction of the left extent, the radiation pattern is induced to create a sound pressure level null 28 angled towards the region of the left listener's 20 ipsilateral ear and a region of comparatively high sound level output orientated to the right listener's 22 ipsilateral ear (wherein the term “ipsilateral ear” refers to the ear on the same side of the listener as the loudspeaker system 12). This can be achieved by driving each transducer 14, 16 based on an upmix extracted left channel signal, but with the left audio driving signal for driving the left transducer 14 including an inverted and time delayed version of the upmix extracted left channel signal with respect to the upmix extracted left channel signal included in the right driving signal for driving the right transducer 16. The time delay Δt_{LR} can be calculated according to the radiation function parameter r, after Southern, A. & Murphy, D., “Low complexity directional sound sources for finite difference time domain room acoustic models,” 126^{th} Audio Engineering Society Convention, Munich, Germany, May 2009:

$$r = \frac{τ - α τ}{α τ} ; α ∈ ( 0 , 1 ]$$

where τ is defined as the ratio of the displacement, x (m), between the centre of the left and right transducers 14, 16 and the speed of sound in air, c (ms⁻¹), hence

$$τ = \frac{x}{c} ( s )$$

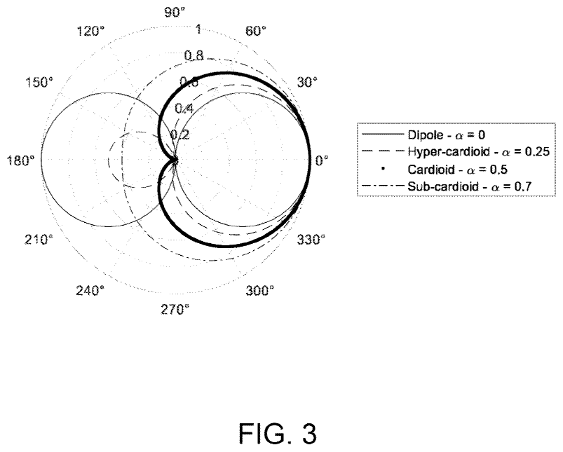

and α is a directivity parameter with 0<α<=1 which describes the transition of a resulting radiation function from 2D monopole (α=0) to 2D dipole (α=1) (see, e.g. Southern, A. & Murphy, D., “Low complexity directional sound sources for finite difference time domain room acoustic models,” 126th Audio Engineering Society Convention, Munich, Germany, May 2009). For instance, the resulting radiation function parameter for α=0.5 describes the well-known cardioid directivity polar pattern. Examples of first-order directivity functions corresponding to different values of a are shown in FIG. 3. With the variability of α, it is possible to direct the required sound pressure level null across all angles

$$θ ϵ [ 0 , \frac{π}{2} ]$$

with respect to the centre line of the listening environment 10 as the directivity function transitions from dipole (α=1) to cardioid (α=0.5). With knowledge of the required radiation function parameter value for a given null angle, the time delay, Δt_{LR}, to be applied to the upmix extracted left channel signal driving the left-most driver (relative to the left channel signal driving the right-most driver) is defined as:

$$Δ {t}_{L R} = r τ$$

There are three effects of importance for null-steering the left extent audio in this manner. Firstly, the null 28 is defined to be directed towards the left listener's 20 ipsilateral ear leading to an increase in Interaural Level Difference (ILD) between the sound pressure levels experienced in the region of the contralateral and ipsilateral ears, in favour of the contralateral ear. The contralateral ear refers to the ear on an opposite side of the listener to the loudspeaker system 12.

Secondly, at the same time, the directivity pattern produced through null-steering in this manner provides a local magnitude radiation maximum 30 directed towards the left extent of the listening environment 10, perpendicular to the centre line, giving rise to strong early reflections being perceived in the region of the left listener's 20 contralateral ear. This further increases the ILD in favour of the contralateral ear and, thus, the left extent of the soundstage is perceived by the left listener 20 as emanating from the region of the left extent of the listening environment 10. In this way a virtual secondary sound source is created in the region of the left extent of the listening environment 10 and this secondary sound source provides the left extent of the reproduced stereo active arc for the left listener 20.

Thirdly, and simultaneously, the radiation pattern formed to provide the aforementioned effects on the left side of the centre line also induces a magnitude radiation maximum 32 with a wider surrounding lobe directed towards the right extent of the enclosure, again perpendicular to the centre line. This then provides sufficient sound pressure level output in the direction of the right listener's 22 ipsilateral ear, thus rendering the left extent signal in such a manner that it is perceived as emanating from the region of the loudspeaker system 12 as required for the left extent of the simultaneous active arc for the right listener 22.

A further contribution of the null-steering operation is borne of the resulting sound radiation pattern symmetry around the perpendicular of the centre line. This directs a null away from the listeners 20, 22, which in some embodiments would be towards a vertical planar wall or screen surface of the listening environment 10 and, therefore, early first-order specular reflections between the loudspeaker system 12 and the left listener's 20 ipsilateral ear which would exist in absence of null-steering, are also suppressed. This again reinforces the perceived direction of arrival as being in the region of the left extent of the listening environment for the left listener 20.

The combination of regions of directional sound cancellation and reinforcement, together with early reflection patterns within the frontal region of the listening environment 10, culminate in the production of the left extent of the two simultaneous active arcs. In an axisymmetric manner, around the centre line of the loudspeaker system 12, the right extents of the simultaneous active arcs are produced via corresponding means as the left extent (i.e. each transducer 14, 16 is driven based on an upmix extracted right channel signal, but with the right audio driving signal for driving the right transducer 16 including a version of the upmix extracted right channel signal which has been inverted and delayed with respect to the upmix extracted right channel signal included in the left audio driving signal for driving the left transducer 14). That is, the same arrangement is created for the right extents of the active arcs by mirroring the radiation pattern shown in FIG. 2 around the centre line of the listening environment 20. Right extent reproduction occurs in tandem with left extent reproduction through signal summation as will now be described with reference to FIG. 4.

FIG. 4 is a flowchart showing a method 40 for generating a left audio driving signal and a right audio driving signal based on a two-channel stereo audio signal, according to an aspect of the present invention. At step 42, a two-channel stereo audio signal is received. The two-channel stereo audio signal consists of a left-channel audio signal and a right channel audio signal.

At step 44, a left audio signal L_{A}(t), a right audio signal R_{A} (t), and a centre audio signal C_{A}(t) are generated based on the two-channel stereo audio signal. In particular, the left, right and centre audio signals may be extracted from the two-channel stereo audio signal via means of a suitable 2- to 3-channel upmixer. The audio signals are generated such that the left and right audio signals are not positively correlated, for reasons which will become apparent below.

At step 46, a first audio signal S₁(t) and a second audio signal S₂(t) are generated based on the left audio signal and the right audio signal, in accordance with the following equations:

$${S}_{1} ( t ) = {R}_{A} ( t ) - {L}_{A} ( t - Δ {t}_{L R} )$$

$${S}_{2} ( t ) = {L}_{A} ( t ) - {R}_{A} ( t - Δ {t}_{L R} )$$

where Δt_{LR} is the time delay selected to steer the radiation null 28 (by generating a particular radiation pattern) as previously described.

At step 48, a left audio driving signal L_{D}(t) for driving the left transducer 14 is derived from a summation of the first audio signal S₁(t) and the centre audio C_{A}(t), e.g. as follows:

$${L}_{D} ( t ) = {R}_{A} ( t ) - {L}_{A} ( t - Δ {t}_{L R} ) + {C}_{A} ( t )$$

At step 49, a right audio driving signal R_{D}(t) for driving the right transducer 16 is derived from a summation of the second audio signal S₁(t) and the centre audio C_{A}(t), e.g. as follows:

$${R}_{D} ( t ) = {L}_{A} ( t ) - {R}_{A} ( t - Δ {t}_{LR} ) + {C}_{A} ( t )$$

These formulations bring about the aforementioned necessity for deriving largely decorrelated left and right audio signals from the received two-channel stereo audio signal via means of a suitable 2- to 3-channel upmixer. It is evident from the signal formulations above that any correlated content common to the original left and right channel audio signals would give rise to signal cancellation via comb filtering brought about by the summation of such common content to a delayed version of such common content in both left and right audio driving signals. This is to be avoided as far as feasibly possible within the limits of operation of the upmixer of choice when generating left and right audio driving signals to establish optimal independence between the reproduced left and right extent signals in the interests of maintaining the width of the resulting active arcs.

The centre audio signal extracted from the received two-channel stereo audio signal is defined as the (largely) correlated signal content common to both the original left-channel audio signal and the right channel audio signal as extracted using a 2- to 3-channel upmix algorithm. According to the method of FIG. 4, the centre audio driving signal is configured to be output through left and right transducers 14, 16 simultaneously to reproduce the centre channel content.

Optionally, a gain stage may be applied to either the centre, left or right audio driving signals, to weight the prominence of the signal content in the output and accommodate for the acoustical properties of the transducers 14, 16 and their positions in space. This also applies to method 80 described below.

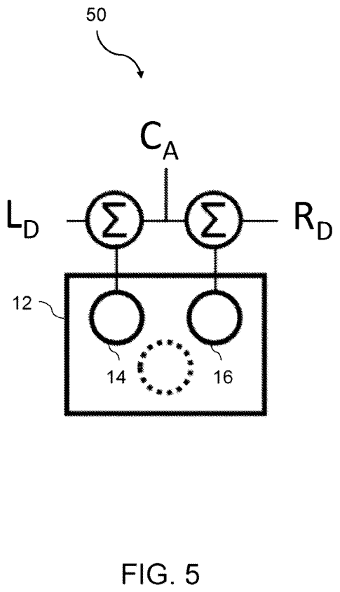

FIG. 5 is a schematic diagram illustrating an audio system 50 including the loudspeaker system 12 comprising the upward-facing left and right transducers 14, 16. The audio system 50 further comprises one or more digital signal processors configured to perform the method of FIG. 4. In particular, FIG. 5 provides an illustration of the signal processing required to provide first-order polar radiation patterns from the left and right transducers 14, 16.

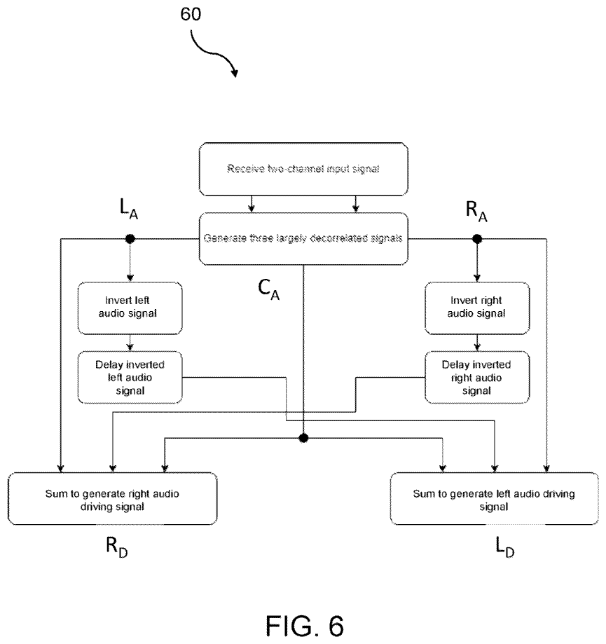

FIG. 6 is a flowchart showing method steps for generating left and right audio driving signals according to a specific embodiment of FIG. 4. In this embodiment, copies of the left and right audio signals are generated. Next, the copy of the right audio signal and the copy of the left audio signal are each inverted, and then the time delay Δt_{LR} is applied to the inverted copies of the right and left audio signals. The right audio signal and the delayed and inverted copy of the left audio signal are summed to generate the first audio signal, whilst the left audio signal and the delayed and inverted copy of the right audio signal are summed to generate the second audio signal. Finally, the centre audio signal is summed with each of the first and second audio signals to create the left and right audio driving signals.

The skilled person will appreciate that, in alternative embodiments, the inversion and delay operations may be alternatively applied. For example, in one embodiment, the time delay(s) may be applied prior to the inversion(s). In another embodiment, generating the first audio signal and the second audio signal may comprise: generating inverted copies of the left and right audio signals, generating time delayed copies of the left and right audio signals, inverting a summation of the inverted copy of the right audio signal and the delayed copy of the left audio signal to generate the first audio signal, and inverting a summation of the inverted copy of the left audio signal and the delayed copy of the right audio signal to generate the second audio signal.

Next, an alternative aspect of the invention will be described in which left, right and centre audio driving signals are generated based on a two-channel stereo audio signal, for use in driving left, right and centre transducers 14, 16, 18 respectively.

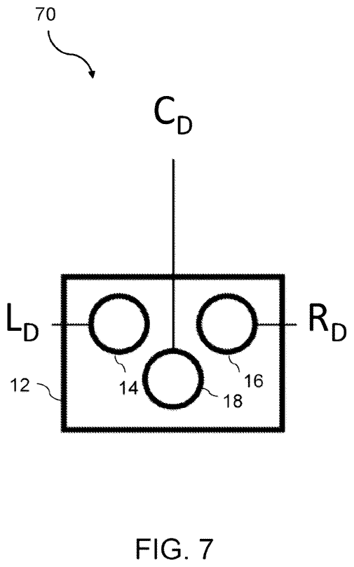

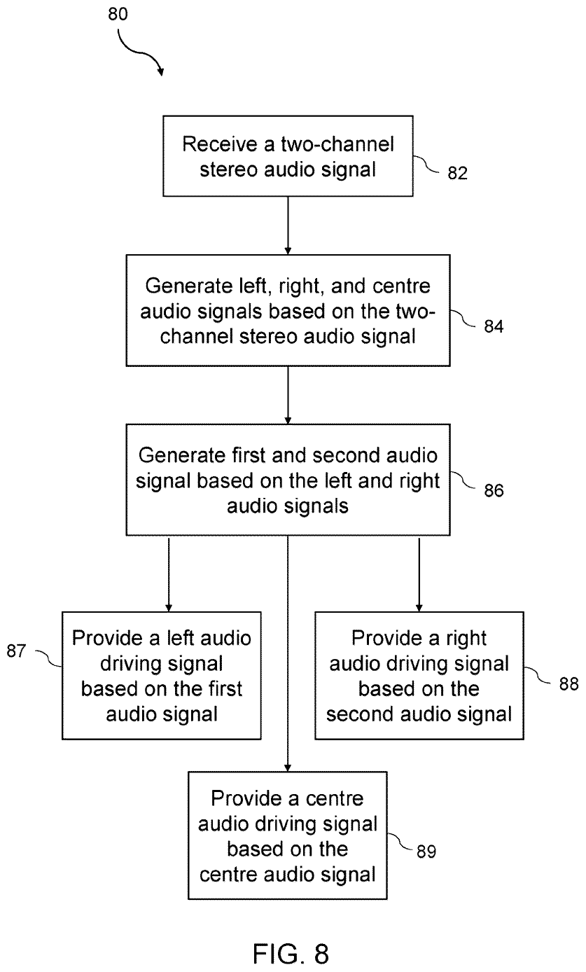

FIG. 7 is a schematic diagram illustrating an audio system 70 in which the loudspeaker system 12 further comprises a centre transducer 18. The centre transducer 18 is located symmetrically between the left transducer 14 and the right transducer 16. The centre transducer 18 is offset from a line extending between the centre of each of the left and right transducers 14, 16. The centre transducer 18 is configured to output a centre audio driving signal which may be generated in accordance with the method of FIG. 8.

FIG. 8 is a flowchart showing a method 80 for generating left, right and centre audio driving signals based on a two-channel stereo audio signal. The method includes steps 82 to 86 which correspond to steps 42 to 46 of method 40.

Next, at step 87, a left audio driving signal L_{D}(t) is provided based on the first audio signal. At step 88, a right audio driving signal R_{D}(t) is provided based on the second audio signal. At step 89, a centre audio driving signal C_{D}(t) is provided based on the centre audio signal. The left, right and centre audio driving signals are configured to be output concurrently through the left, right and center transducers 14, 16, 18 respectively.

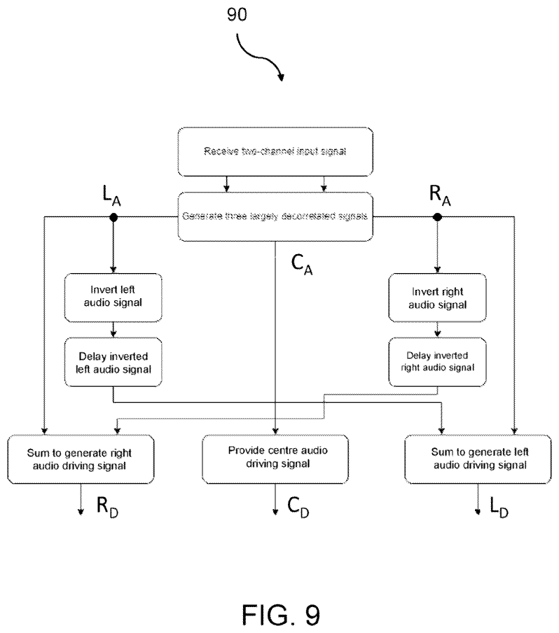

In one embodiment, for example as illustrated in the specific method of FIG. 9, the left audio driving signal may be based on the first audio signal only, the right audio driving signal may be based on the second audio signal only, and the centre audio driving signal may be based on the centre audio signal only. This may be defined as follows:

$$\begin{matrix}{L}_{D} ( t ) = {R}_{A} ( t ) - {L}_{A} ( t - Δ {t}_{LR} ) \\ {R}_{D} ( t ) = {L}_{A} ( t ) - {R}_{A} ( t - Δ {t}_{LR} ) \\ {C}_{D} ( t ) = {C}_{A} ( t )\end{matrix}$$

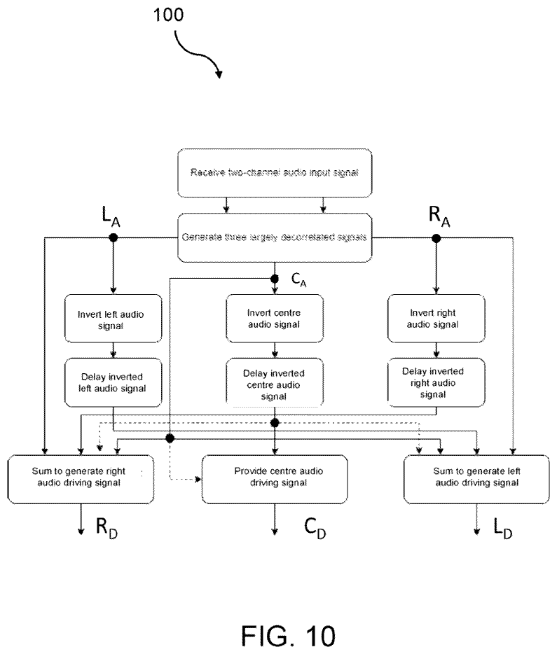

However, if the centre audio content is output exclusively through the centre transducer 18, this results in the centre audio content being perceived as originating from the centre transducer 18. It is desirable to provide a perceived centre channel sound stage which is extended and exists beyond the physical dimensions of the loudspeaker system 12 such that a centre channel contribution is heard as emanating from a more central location within the active arcs. Therefore, in another embodiment, for example as illustrated in the specific method of FIG. 10 (noting that the dashed lines in the flowchart indicate an alternative sequence of steps), a third audio signal S₃(t) may be generated based on the centre audio signal, wherein the third audio signal is generated according to the following equation:

$${S}_{3} ( t ) = - {C}_{A} ( t - Δ {t}_{C} )$$

where Δt_{C} is a time delay applied to the centre audio signal. The left audio driving signal may then be generated based on a summation of the first audio signal and one of the centre audio signal and the third audio signal, the right audio driving signal may be generated based on a summation of the second audio signal and the one of the centre audio signal and the third audio signal, and the centre audio driving signal may be generated based on the other of the centre audio signal and the third audio signal. For example, the left audio driving signal L_{D}(t), the right audio driving signal R_{D}(t), and the centre audio driving signal C_{D}(t) may be defined as follows:

$$\begin{matrix}{L}_{D} ( t ) = {R}_{A} ( t ) - {L}_{A} ( t - Δ {t}_{LR} ) + {C}_{A} ( t ) \\ {R}_{D} ( t ) = {L}_{A} ( t ) - {R}_{A} ( t - Δ {t}_{LR} ) + {C}_{A} ( t ) \\ {C}_{D} ( t ) = - {C}_{A} ( t - Δ {t}_{C} )\end{matrix}$$

Or as:

$$\begin{matrix}{L}_{D} ( t ) = {R}_{A} ( t ) - {L}_{A} ( t - Δ {t}_{LR} ) - {C}_{A} ( t - Δ {t}_{C} ) \\ {R}_{D} ( t ) = {L}_{A} ( t ) - {R}_{A} ( t - Δ {t}_{LR} ) - {C}_{A} ( t - Δ {t}_{C} ) \\ {C}_{D} ( t ) = {C}_{A} ( t )\end{matrix}$$

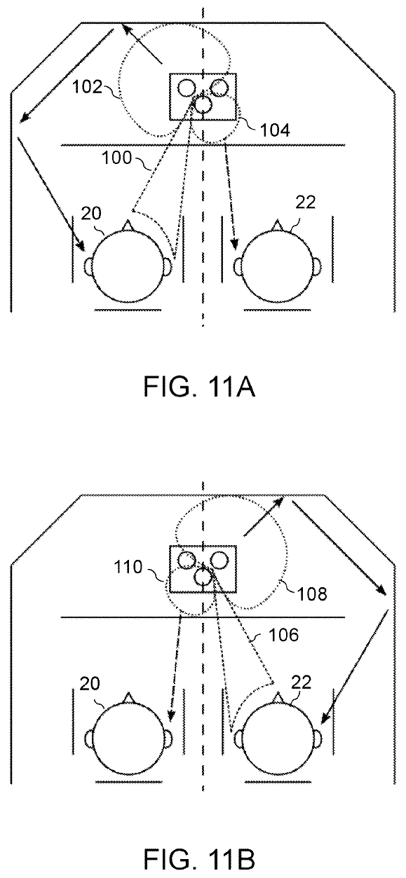

Processing of the centre audio signal in this manner (i.e. applying inversion and time delay operations) results in two simultaneous radiation patterns being formed when the left, right and centre audio driving signals are simultaneously output by the left, right and centre transducers 14, 16, 18 respectively. As illustrated in FIGS. 11A and 11B, the time delay Δt_{C} is calculated (based on the same methodology as described with respect to Δt_{LR} above) such that the resulting radiation patterns have sound pressure level nulls 100, 106 which are steered in the direction of the left and right listener's 20, 22 ipsilateral ears, noting that this centre channel reproduction method is symmetrical about the centre line of the listening environment 10. In addition, the time delay Δt_{C} may be selected such that global radiation maximums 102, 108 are directed away from the listeners 20, 22. As a result, strong reflections emanating from front and side surfaces of the listening environment 10 (if present) compliment the reduced ILD provided by the directivity nulls such that the stereo-centre audio content is perceived as originating from a central region of the rendered simultaneous active arcs.

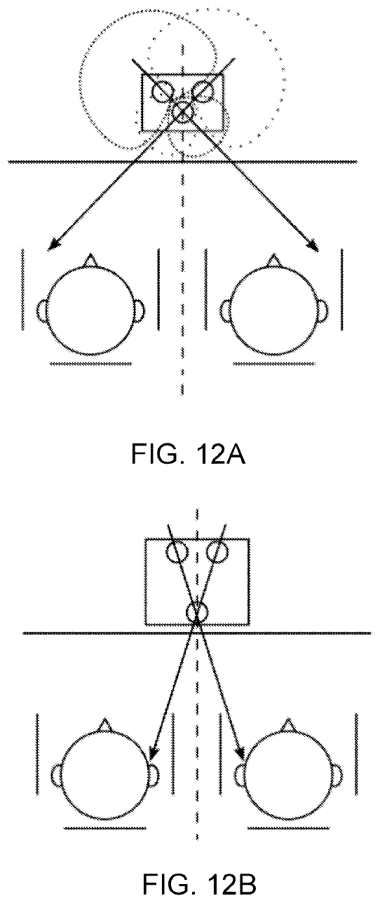

Another important factor to consider is the positioning of the centre transducer 18 along the centre line of the listening environment 10, i.e. with respect to the left and right transducers 14, 16 and the left and right listeners 20, 22. In a preferred embodiment, the centre transducer 18 is arranged such that the lines intersecting the central points of the centre transducer 18 and the left and right transducers 14, 16 may be extrapolated to regions of the adjacent listening regions which are not in the region of the ipsilateral ear of either listener 20, 22. This positioning factor is depicted in FIG. 12A and its consideration shown to be of importance given the scenario shown in FIG. 12B in which the location of the centre transducer 18, relative to the left and right transducers 14, 16, greatly changes the look direction of the extrapolated lines of intersection such that they are directed towards the ipsilateral ears of both listeners 20, 22. Such an arrangement requires careful selection of signal delay factors such that the null for simultaneous centre channel signal positioning is steered towards the ipsilateral ear for both listeners 20, 22.

To summarise the above, method 40 provides a method for generating audio driving signals for driving left and right transducers 14, 16 only. In this case, the upmix extracted centre audio signal may be used to drive the left and right transducers 14, 16 concurrently with no further processing of the signal required. The perceived sound source region of the centre audio signal content will therefore approximate the dimensions of the loudspeaker system 12 of left and right transducers 14, 16 in terms of width. Alternatively, method 80 provides a method for generating audio driving signals for driving left and right transducers 14, 16 and additionally a centre transducer 18 which is positioned on the longitudinal centre line of the listening environment 10. In this case, when the centre transducer 18 is longitudinally offset with respect to the left and right transducers 14, 16, it is advantageous that the centre audio driving signal is delayed or advanced to accommodate time alignment of wave fronts at the listening positions of left and right listener 20, 22.

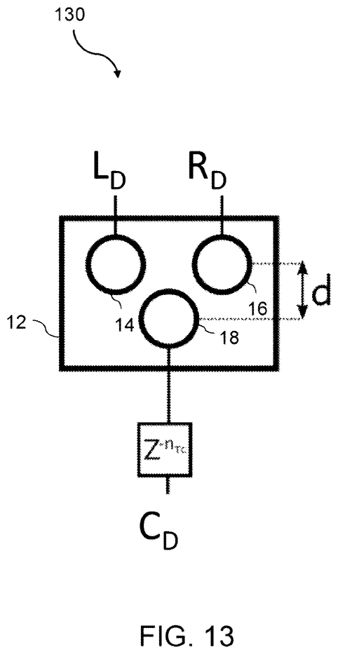

For example, as per FIG. 13 which illustrates an audio system 130 comprising left, right and centre transducers 14, 16, 18 in which the centre transducer 18 is displaced along the longitudinal axis with respect to the left and right transducers 14, 16 by a distance d (m) towards the listening locations, a time delay of n_{tc} samples is applied to the centre audio driving signal in order to provide the appropriate time alignment, where:

$${n}_{tc} = \frac{d}{c} Fs ( samples )$$

for a given wave speed, c (m/s), and digital audio sampling rate, Fs (Hz). The skilled person will also appreciate that if the centre transducer 18 is alternatively offset behind the left and right transducers 14, 16 with respect to the left and right listeners 20, 22, the left and right audio driving signals may instead be delayed.

The present invention may also be implemented with the inclusion of a panning algorithm to move the perceived acoustic location of the upmix extracted centre audio signal in space towards the left or right extent of the active arc. The following equations show the calculation of the gain coefficients:

$$\begin{matrix}{G}_{CL} = \{ \begin{matrix}\sqrt{\vert b \vert} , & b \leq 0 \\ 0 , & b > 0\end{matrix} \\ {G}_{CR} = \{ \begin{matrix}0 , & b \leq 0 \\ \sqrt{\vert b \vert} , & b > 0\end{matrix} \\ {G}_{CC} = \sqrt{1 - \vert b \vert}\end{matrix}$$

where b is the balance parameter ranging from −1 (i.e. a left balance) to 1 (i.e. a right balance), and G_{CL}, G_{CR} and G_{CC} are the resultant gain coefficients for the left, right and centre channels respectively.

The method of gain application is shown in the following:

$$\begin{matrix}{C}_{A} ( t ) = {C}_{U} ( t ) \times {G}_{CC} \\ {L}_{A} ( t ) = {L}_{U} ( t ) + {10}^{\frac{{G}_{M}}{20}} ( {C}_{U} ( t ) \times {G}_{CL} ) \\ {R}_{A} ( t ) = {R}_{U} ( t ) + {10}^{\frac{{G}_{M}}{20}} ( {C}_{U} ( t ) \times {G}_{CR} )\end{matrix}$$

where G_{M} is a constant value of make up gain which can be applied to keep a consistent volume as the signal is panned, and L_{U}(t), R_{U}(t) and C_{U}(t) are the left, right and centre upmix audio signals generated by applying 2- to 3-channel upmixing to the two-channel stereo audio signal. It will be understood that in alternative embodiments in which a panning algorithm is not applied, the relationship between the left, right and centre upmix audio signals and the left, right and centre audio signals will typically be defined as follows:

$$\begin{matrix}{C}_{A} ( t ) = {C}_{U} ( t ) \\ {L}_{A} ( t ) = {L}_{U} ( t ) \\ {R}_{A} ( t ) = {R}_{U} ( t )\end{matrix}$$

In other embodiments, the relationship between the left, right and centre upmix audio signals and the left, right and centre audio signals may instead be defined as:

$$\begin{matrix}{C}_{A} ( t ) = - {C}_{U} ( t ) \\ {L}_{A} ( t ) = - {L}_{U} ( t ) \\ {R}_{A} ( t ) = - {R}_{U} ( t )\end{matrix}$$

That is, the left, right and centre audio signals may correspond to inverted versions of the left, right and centre upmix audio signals. In this case, a later inversion operation will be applied when generating each of the left, right and centre audio driving signals. It will be appreciated that the left, right and centre upmix audio signals may also be inverted when applying the panning algorithm above.

The timbral voicing and spectral balancing of the overall soundfield produced by the loudspeaker system 12 can be altered (in any embodiment) by means of well-established signal processing routines. Of particular note is the manifestation of first-order high pass filter response characteristics in the resulting overall soundfield produced by two sound sources acting together to produce first-order directivity patterns (as per those mentioned previously). The spectral imbalance of low to high frequency range energy resulting from these response characteristics is remedied by deployment of appropriate filtering strategies which are tuned depending on the resulting spectral characteristics of the selected first-order directivity function/s applied (in order to achieve the desired null-steering configuration(s)).

1. A method of generating audio driving signals based on a two-channel stereo audio signal, for use in driving upward-firing transducers, the method comprising the steps of:
receiving a two-channel stereo audio signal;
generating a left audio signal L_{A}(t), a right audio signal R_{A} (t), and a centre audio C_{A}(t) signal based on the two-channel stereo audio signal, wherein the left and right audio signals are not positively correlated;
generating a first audio signal S₁(t) and a second audio signal S₂(t) based on the left and right audio signals, wherein the first audio signal and the second audio signal are generated according to: S₁(t)=R_{A} (t)−L_{A}(t−Δt_{LR}) and S₂(t)=L_{A}(t)−R_{A} (t−Δt_{LR}), where Δt_{LR} is a time delay for the left and right audio signals;
providing a left audio driving signal L_{D}(t) for driving an upward-firing left transducer, wherein the left audio signal is derived from a summation of the first audio signal and the centre audio signal; and
providing a right audio driving signal R_{D}(t) for driving an upward-firing right transducer, wherein the right audio signal is derived from a summation of the second audio signal and the centre audio signal.

2. The method of claim 1, wherein providing the left audio driving signal comprises applying a gain stage to at least one of the first audio signal and the centre audio signal prior to the summation of the first audio signal and the centre audio signal, and/or
wherein providing the right audio driving signal comprises applying a gain stage to at least one of the second audio signal and the centre audio signal prior to the summation of the second audio signal and the centre audio signal.

3. A method of generating audio driving signals based on a two-channel stereo audio signal, for use in driving upward-firing transducers, the method comprising the steps of:
receiving a two-channel stereo audio signal;
generating a left audio signal L_{A}(t), a right audio signal R_{A} (t), and a centre audio C_{A}(t) signal based on the two-channel stereo audio signal, wherein the left and right audio signals are not positively correlated;
generating a first audio signal S₁(t) and a second audio signal S₂(t) based on the left and right audio signals, wherein the first audio signal and the second audio signal are generated according to: S₁(t)=R_{A} (t)−L_{A}(t−Δt_{LR}) and S₂(t)=L_{A}(t)−R_{A} (t−Δt_{LR}), where Δt_{LR} is a time delay for the left and right audio signals;
providing a left audio driving signal L_{D}(t) for driving an upward-firing left transducer, wherein the left audio driving signal is derived from the first audio signal;
providing a right audio driving signal R_{D}(t) for driving an upward-firing right transducer, wherein the right audio driving signal is derived from the second audio signal; and
providing a centre audio driving signal C_{D}(t) for driving an upward-firing centre transducer, wherein the centre audio driving signal is derived from the centre audio signal.

4. The method of claim 3, wherein the left audio driving signal is derived from the first audio signal only, wherein the right audio driving signal is derived from the second audio signal only, and wherein the centre audio driving signal is derived from the centre audio signal only.

5. The method of claim 4, wherein providing the left audio driving signal comprises applying a gain stage to the first audio signal, and/or
wherein providing the right audio driving signal comprises applying a gain stage to the second audio signal, and/or
wherein providing the centre audio driving signal comprises applying a gain stage to the centre audio signal.

6. The method of claim 3, further comprising generating a third audio signal S₃(t) based on the centre audio signal, wherein the third audio signal is generated according to: S₃(t)=−C_{A}(t−Δt_{C}), where Δt_{c} is a time delay for the centre audio signal,
wherein the left audio driving signal is derived from a summation of the first audio signal and one of the centre audio signal and the third audio signal,
wherein the right audio driving signal is derived from a summation of the second audio signal and the one of the centre audio signal and the third audio signal, and
wherein the centre audio driving signal is derived from the other of the centre audio signal and the third audio signal.

7. The method of claim 6, wherein providing the left audio driving signal comprises applying a gain stage to at least one of the first audio signal, the centre audio signal, and the third audio signal prior to the summation of the first audio signal and the one of the centre audio signal and the third audio signal, and/or
wherein providing the right audio driving signal comprises applying a gain stage to at least one of the second audio signal, the centre audio signal, and the third audio signal prior to the summation of the second audio signal and the one of the centre audio signal and the third audio signal, and/or
wherein providing the centre audio driving signal comprises applying a gain stage to the other of the centre audio signal and the third audio signal.

8. The method of claim 6, wherein the time delay Δt_{c} is selected such that, when the left audio driving signal, the right audio driving signal and the centre audio driving signal are used to simultaneously drive respective upward-facing left, right and centre transducers located symmetrically ahead of and between a left listener and a right listener, sound radiation patterns associated with the centre audio signal are output having nulls directed towards the left listener's ipsilateral ear and the right listener's ipsilateral ear.

9. The method of claim 3, further comprising applying a time delay n_{tc} to the centre audio driving signal or the left and right audio driving signals such that, when the left audio driving signal, the right audio driving signal and the centre audio driving signal are used to simultaneously drive respective upward-facing left, right and centre transducers located ahead of and symmetrically between a left listener and a right listener, sound radiation patterns received by the left and right listeners are time aligned.

10. The method of claim 9, wherein the time delay n_{tc} is calculated according to:
$${n}_{tc} = \frac{d}{c} Fs$$
wherein d is a perpendicular displacement of the upward-facing centre transducer from a line extending between the upward-facing right and left transducers, c is the speed of sound in air, and Fs is a digital sampling rate of the audio driving signals.

11. The method of claim 3, wherein the centre audio driving signal is band-limited.

12. The method of claim 3, wherein the time delay Δt_{LR} is selected such that, when the left audio driving signal and the right audo driving signal are used to simultaneously drive respective upward-facing left and right transducers located symmetrically ahead of and between a left listener and a right listener, a sound radiation pattern associated with the left audio signal is output having a null directed towards the left listener's ipsilateral ear and a sound radiation pattern associated with the right audio signal is output having a null directed towards the right listener's ipsilateral ear.

13. The method of claim 3, wherein Δt_{LR} is calculated according to:
$$Δ {t}_{LR} = \frac{τ - ατ}{α} ; α ∈ ( 0 , 1 ]$$
where α is a directivity parameter with 0<α<=1,
$$τ = \frac{x}{c}$$
where x (m) is a distance between a centre of upward-facing left and right transducers and c (ms⁻¹) is the speed of sound in air.

14. The method of claim 3, further comprising generating the left audio signal, the right audio signal, and the centre audio signal by:
upmixing the two-channel stereo audio signal to generate a left upmix audio signal L_{U}(t), a right upmix audio signal R_{U}(t), and a centre upmix audio signal C_{U}(t), wherein the left audio signal, the right audio signal, and the centre audio signal are derived from the left upmix audio signal, the right upmix audio signal, and the centre upmix audio signal respectively.

15. The method of claim 14, further comprising:
applying a panning algorithm to the left upmix audio signal, the right upmix audio signal, and the centre upmix audio signal to generate the left audio signal, the right audio signal, and the centre audio signal respectively.

16. The method of claim 15, wherein the panning algorithm generates the left audio signal, the right audio signal, and the centre audio signal in accordance with:
$$\begin{matrix}{C}_{A} ( t ) = {C}_{U} ( t ) \times {G}_{CC} \\ {L}_{A} ( t ) = {L}_{U} ( t ) + {10}^{\frac{{G}_{M}}{20}} ( {C}_{U} ( t ) \times {G}_{CL} ) \\ {R}_{A} ( t ) = {R}_{U} ( t ) + {10}^{\frac{{G}_{M}}{20}} ( {C}_{U} ( t ) \times {G}_{CR} )\end{matrix}$$
where G_{M} is a make-up gain parameter and G_{CL}, G_{CR} and G_{CG} are gain coefficients which are calculated in accordance with:
$$\begin{matrix}{G}_{CL} = \{ \begin{matrix}\sqrt{\vert b \vert} , & b \leq 0 \\ 0 , & b > 0\end{matrix} \\ {G}_{CR} = \{ \begin{matrix}0 , & b \leq 0 \\ \sqrt{\vert b \vert} , & b > 0\end{matrix} \\ {G}_{CC} = \sqrt{1 - \vert b \vert}\end{matrix}$$
where b is a balance parameter ranging from −1 to 1.

17. The method of claim 3, further comprising:
applying one or more spectral equalisation filters to one or more of the audio driving signals.

18. The method of claim 3, further comprising applying a gain stage to one or more of the audio driving signals.

19. A computer program product comprising instructions which, when the program is executed by a computer, cause the computer to carry out the method of claim 1.

20. An audio system comprising one or more digital signal processors adapted to perform a method of generating audio driving signals based on a two-channel stereo audio signal, for use in driving upward-firing transducers, the method comprising the steps of:
receiving a two-channel stereo audio signal;
generating a left audio signal L_{A}(t), a right audio signal R_{A} (t), and a centre audio C_{A}(t) signal based on the two-channel stereo audio signal, wherein the left and right audio signals are not positively correlated;
generating a first audio signal S₁(t) and a second audio signal S₂(t) based on the left and right audio signals, wherein the first audio signal and the second audio signal are generated according to: S₁(t)=R_{A} (t)−L_{A}(t−Δt_{LR}) and S₂(t)=L_{A}(t)−R_{A} (t−Δt_{LR}), where Δt_{LR} is a time delay for the left and right audio signals;
providing a left audio driving signal L_{D}(t) for driving an upward-firing left transducer, wherein the left audio signal is derived from a summation of the first audio signal and the centre audio signal; and
providing a right audio driving signal R_{D}(t) for driving an upward-firing right transducer, wherein the right audio signal is derived from a summation of the second audio signal and the centre audio signal.

21. The audio system of claim 20, further comprising:
an upward-firing left transducer configured to be driven by the left audio driving signal; and
an upward-firing right transducer configured to be driven by the right audio driving signal.

22. The audio system of claim 21, further comprising:
an upward-firing centre transducer configured to be driven by the centre audio driving signal, wherein the upward-firing centre transducer is located between the upward-firing left and right transducers.

23. The audio system of claim 22, wherein the upward-facing centre transducer has different acoustic characteristics to the upward-firing left and right transducers.

24. The audio system of claim 21, wherein the upward-firing left and right transducers have substantially the same acoustic characteristics within the audible bandwidth 20 Hz to 20000 Hz.

25. A vehicle comprising the audio system according to claim 21, wherein the upward-facing transducers are mounted inside a cabin of the vehicle and arranged at the front of the cabin in a loudspeaker system positioned symmetrically about a longitudinal axis of the cabin.
